(19) United States
(12) Patent Application Publication
(10) Pub. No.: US 2007/0214889 A1
(43) Pub. Date: Sep. 20, 2007

(54) Magnetofluidic unidirectional accelerometer

(75) Inventor: Alexander G. Pristup, Novosibirsk (RU)

Correspondence Address: BARDMESSER LAW GROUP, P.C., 910 17TH STREET, N.W., SUITE 800, WASHINGTON, DC, 20006, US

(73) Assignee: Innalabs Technologies, Inc., Dulles, VA (US)

(21) Appl. No.: 11/375,209

(22) Filed: Mar. 15, 2006

(51) Int. Cl. G01P 15/00

(52) U.S. Cl. 73/514.06

(57) ABSTRACT

An accelerometer includes a housing, a magnetic fluid within the housing, and an inertial body suspended in the magnetic fluid and generally constrained to move along a single axis. Centering magnets are positioned on two sides of the inertial body along the axis. A detector provides a signal indicative of acceleration based on displacement of the inertial body. A plurality of stops can be placed on the inertial body inside the housing. A coil winding can be placed on the housing to be coupled to the inertial body for maintaining the inertial body substantially in place. Cavities with air can be on sides of the inertial body. Openings in the housing can be placed at locations of the cavities. The inertial body can have a channel connecting the cavities. The detector can be a Hall sensor, a digital Hall sensor, or two Hall sensors for differential detection of the acceleration. The housing can have two lids that substantially enclose, within the housing, magnetic fields from the centering magnets.

### BACKGROUND OF THE INVENTION

1. Field of the Invention

The present invention is related to magnetofluidic acceleration sensors.

2. Background Art

Magnetofluidic accelerometers are generally known and described in, e.g., U.S. Pat. No. 6,731,268. Such accelerometers utilize magnetofluidic principles and an inertial body suspended in a magnetic fluid, to measure acceleration. Such an accelerometer often includes a sensor casing (sensor housing, or “vessel”), which is filled with magnetic fluid. An inertial body (inertial object, or proof mass) is suspended in the magnetic fluid. The accelerometer usually includes a number of drive coils (power coils) generating a magnetic field in the magnetic fluid, and a number of measuring coils to detect changes in the magnetic field due to relative motion of the inertial body.

One of the problems known in the art of measuring acceleration is the problem of measuring only a single linear component of such acceleration, for example, where the object whose acceleration needs to be measured is restricted in movement only along a single axis. In this case, taking the axis to be the X axis, the technical problem is restricted, from measuring acceleration in all six coordinates (three linear and three angular), to measuring only the acceleration in the X direction. Magneto-fluidic accelerometers are known in the art that can be utilized for this purpose, for example, see R. L. Bailey, Lesser Known Applications of Ferrofluids, Journal of Magnetism and Magnetic Materials 39 (1983), pp. 178-182. One of the problems with conventional accelerometers, such as those described in the referenced literature, is that the magnetic fluid is used both for suspension of an inertial body (proof mass) of such an accelerometer, and as “springs,” so that the magnetic fluid exerts a force against the proof mass when the proof mass is displaced from its neutral position, returning the proof mass back to the neutral position. Since the properties of the magnetic fluid tend to change over time, for example, due to wearing out of the magnetic properties of the fluid, the long-term stability of the measurement is degraded.

Another problem relates to the dimensions of the overall device. Conventional devices tend to be somewhat bulky, given that many of the current applications for such devices require a high degree of miniaturization.

Accordingly, there is a need in the art for a relatively small magneto-fluidic accelerometer with stable long term properties.

### BRIEF SUMMARY OF THE INVENTION

The present invention relates to magnetofluidic unidirectional accelerometers that substantially obviates one or more of the issues associated with known accelerometers.

More particularly, in an exemplary embodiment of the present invention, an accelerometer includes a housing, a magnetic fluid within the housing, and an inertial body suspended in the magnetic fluid and generally constrained to move along a single axis. Centering magnets are positioned on two sides of the inertial body along the single axis. A detector provides a signal indicative of acceleration and based on displacement of the inertial body. A plurality of stops can be placed on the inertial body. A coil winding can be placed on the housing to be coupled to the inertial body for maintaining the inertial body substantially in place. Cavities with air can be on sides of the inertial body. Openings in the housing can be placed at locations of the cavities. The inertial body can have a channel connecting the cavities. The detector can be a Hall sensor, a digital Hall sensor, or two Hall sensors for differential detection of the acceleration, as well as other sensors, such as magnetoresistive sensors, capacitive sensors, etc. The housing can have two lids that substantially enclose, within the housing, magnetic fields from the centering magnets.

In another aspect, an accelerometer includes elements substantially as above, with the inertial body generally constrained to move in a plane in two directions, rather than one.

Additional features and advantages of the invention will be set forth in the description that follows, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE FIGURES

The accompanying drawings, which are included to provide a further understanding of the invention and are incorporated in and constitute a part of this specification, illustrate embodiments of the invention and together with the description serve to explain the principles of the invention. In the drawings:

FIG. 1 illustrates one exemplary embodiment of the invention.

FIG. 2 illustrates the principle of operation of a Hall sensor.

FIG. 3 illustrates how a digital Hall sensor can be used in an embodiment illustrated in, for example, FIG. 1.

FIGS. 4-7 illustrate various alternative exemplary embodiments of the invention.

### DETAILED DESCRIPTION OF THE PREFERRED EMBODIMENTS

Reference will now be made in detail to embodiments of the present invention, examples of which are illustrated in the accompanying drawings.

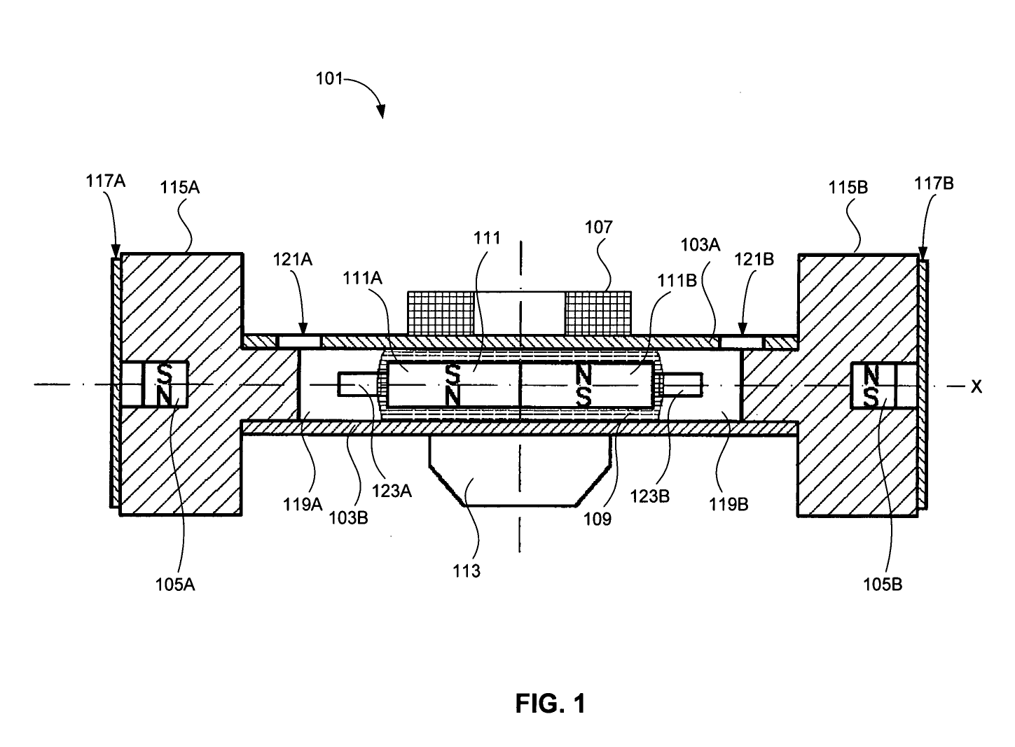

FIG. 1 illustrates one exemplary embodiment of the invention, where the accelerometer is restricted to measuring acceleration along the axis X. As shown in FIG. 1, the accelerometer 101 includes a housing that comprises a top plate 103A and a bottom plate 103B. The housing also includes side portions 115A, 115B, which are attached to the top and bottom plates 103A, 103B, either by press fitting, or by any other mounting or attachment mechanism known in the art.

As further shown in FIG. 1, an inertial body 111 is formed of two magnets, 111A, 111B. Alternatively, the inertial body 111 can be formed as a single magnet, with the magnetic poles as shown, or more than two magnets. The inertial body 111 floats in magnetic liquid 109. The inertial body 111 can also include optional stops 123A, 123B, which can be used to restrict the movement of the inertial body 111 in the X direction. A Hall sensor 113 is mounted on one of the plates 103, to detect movement the inertial body 111. Cavities 119A, 119B, are located on the sides of the inertial body 111, permitting the inertial body to move in the X direction. Openings 121A, 121B are provided in one of the plates 103, to ensure that the inertial body 111 can move without encountering substantial air resistance. It should be noted that without the openings 121A, 121B, the air in the cavities 119A, 119B would act as a spring. This may or may not be desirable.

As further shown in FIG. 1, housing portions 115A, 115B also include centering magnets 105A, 105B. The magnetic coupling between the centering magnets 105A, 105B and the magnets 111A, 111B acts as a type of spring, which returns the inertial body 111 to its neutral position, once the inertial body 111 has been displaced from the neutral position due to acceleration.

Also shown in FIG. 1 are two side caps 117A, 117B. Preferably, these caps 117A, 117B are made of a material that blocks outside magnetic fields, and does not permit, at least to some extent, for the magnetic fields from the magnets 105A, 105B, to stray outside the device.

Also shown in FIG. 1 is a coil winding, or inductive coil 107, which is used to suspend the inertial body 111 in the two axes in which the acceleration is not being measured (in other words, in the Y and Z axes). The coil winding 107 can also be used for active suspension, where the inertial body 111 can be maintained substantially in place, and the acceleration is actually measured by the amount of effort required to maintain the inertial body 111 in place (in other words, by the current required to pass through the winding 107, which is related to the amount of force experienced by the inertial body 111).

The output signal of the accelerometer can also be formed by the Hall sensor 113, which forms its output signal based on the changes in the magnetic field in its immediate surrounding.

As yet a further option, the coil winding 107 can induce vibration of the inertial body 111, which serves to “stir” the magnetic fluid 109, which improves its long term characteristics. This can be done, for example, by passing a high frequency current through the coil winding 107. As yet a further embodiment, the coil winding 107 can be used to pass a calibrated current through it, so that the response of the inertial body 111 can be measured by the Hall sensor, and the accelerometer 101 calibrated.

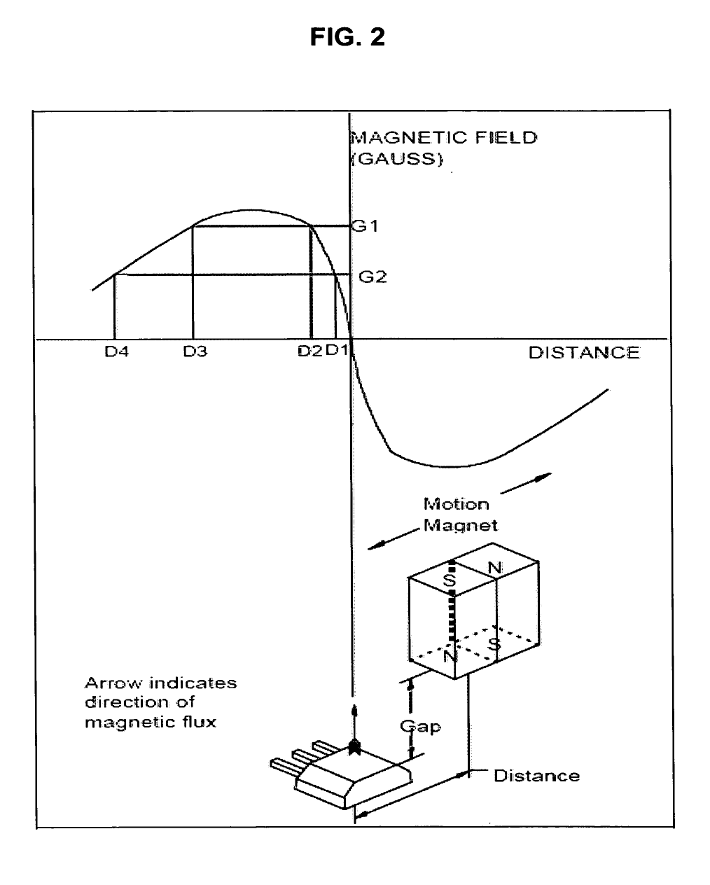

FIG. 2 illustrates the principle of operation of a Hall sensor, such as the Hall sensor 113 illustrated in FIG. 1. It will be understood one of ordinary skill in the art that using a hall sensor is only one way to measure the position and/or displacement of the inertial body 111. Other types of sensors can also be used, for example, capacitive sensors, inductive sensors, optical sensors, etc.

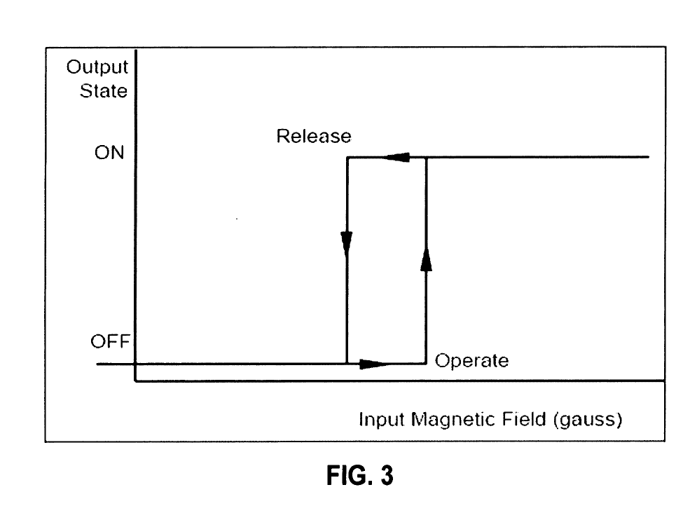

FIG. 3 illustrates how a digital Hall sensor can be used in an embodiment illustrated in, for example, FIG. 1. Using a digital Hall sensor converts the accelerometer, which is essentially an analog device, into a digital-type threshold device. Furthermore, the combination of the coil winding 107 and a digital Hall sensor permits generating a binary signal (e.g., digital 0 or 1, when the measured value exceeds a specified threshold) which can provide a significant benefit for subsequent processing of the accelerometer's signal, simplifying that processing in some circumstances. Note that if the coil winding induces a vibration of the inertial body 111, the output of the accelerometer would be represented by a sequence of digital pulses, whose duration depends on the magnitude of the acceleration and the inclination of the accelerometer.

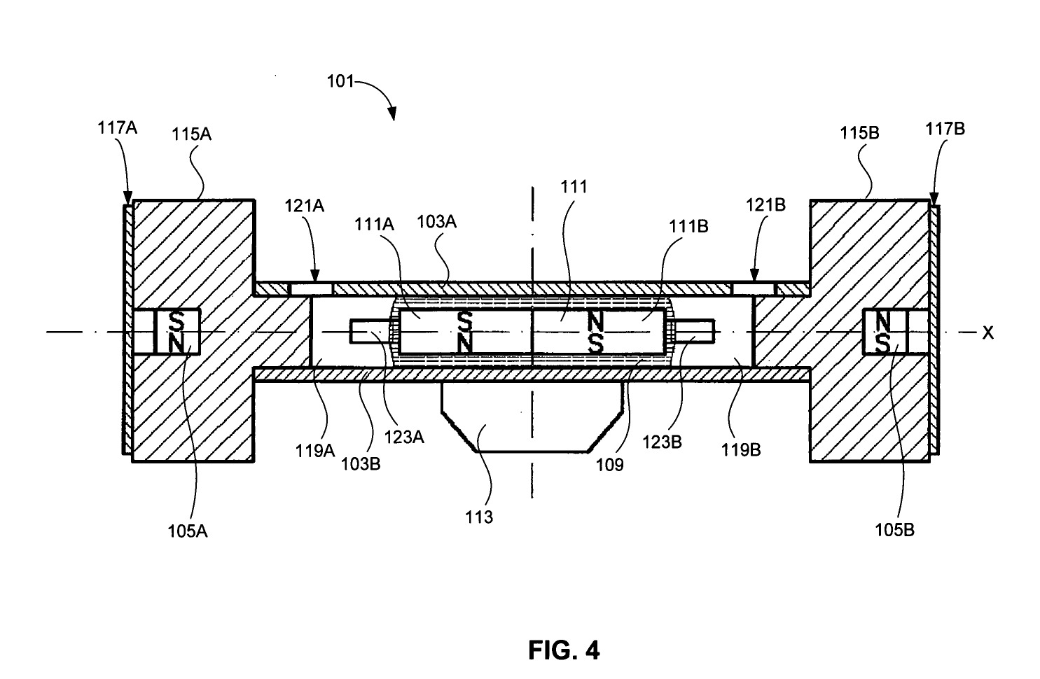

FIG. 4 illustrates another embodiment of the invention. As shown in FIG. 4, the coil winding 107 can be removed, or not used, and the magnetic liquid 109 is magnetized only by the magnetic field generated by the magnets 111A, 111B. This reduces overall size, and cost of the device. On the other hand, without the coil winding 107, it would be difficult to actively control the position of the inertial body 111, or generate a test signal. Other aspects of the device can remain substantially the same as shown in FIG. 1.

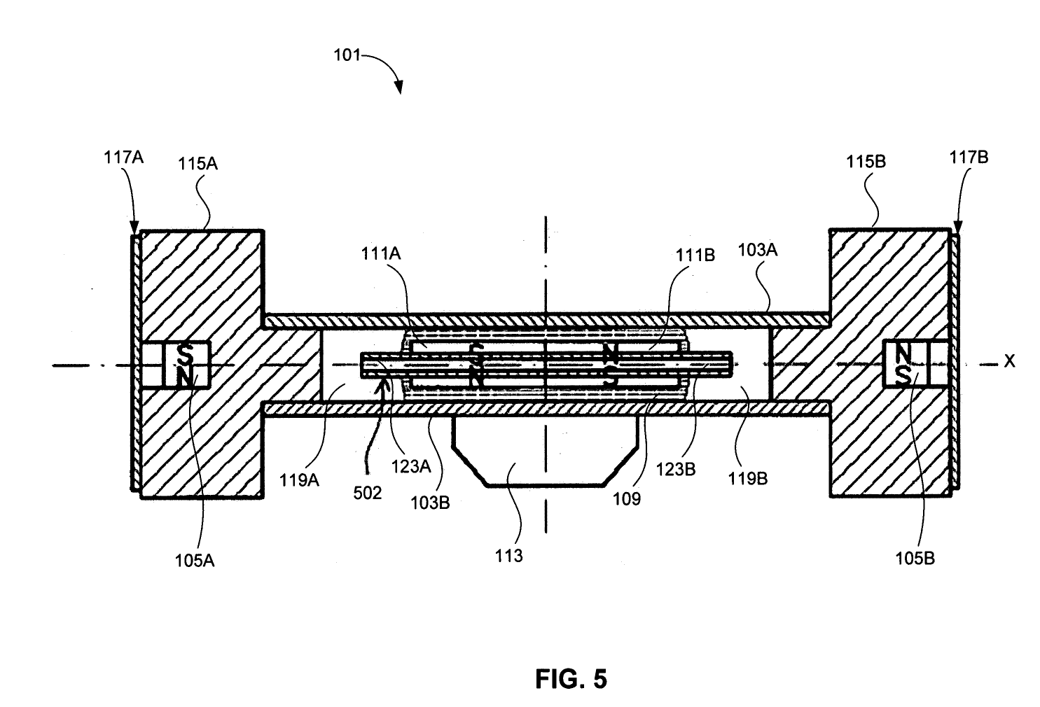

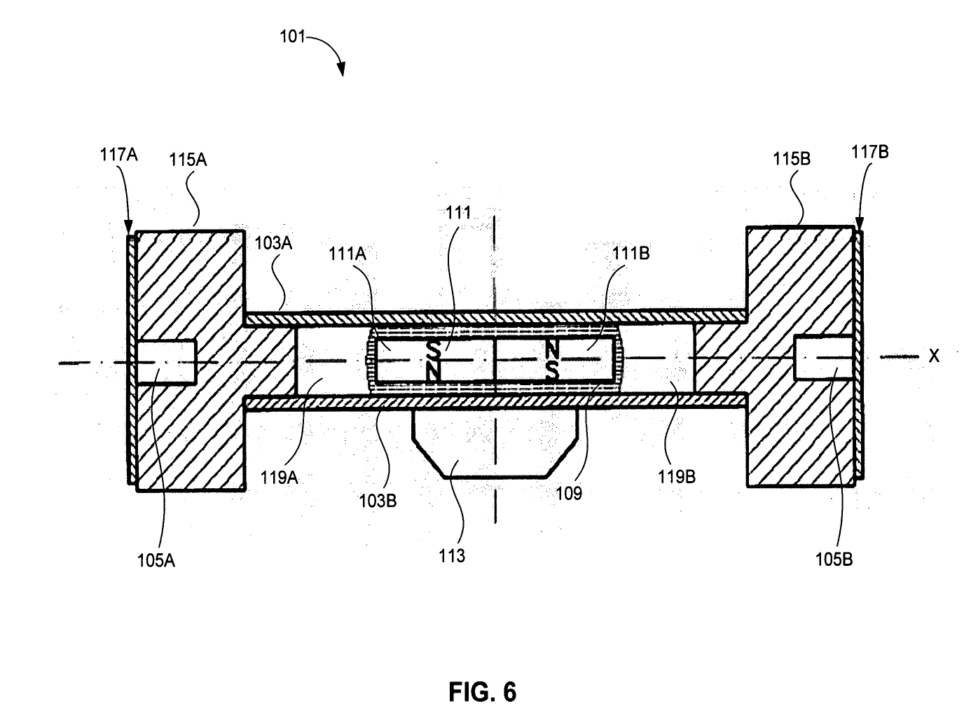

FIG. 5 illustrates another embodiment of the invention. As discussed earlier, the two openings 121A, 121B are used to prevent the air in the cavities 119A, 119B, from acting as springs, since air is compressible, and with the geometries involved, would in fact act as a spring. To avoid this problem, while maintaining the integrity of the housing 103, a conduit 502 can be provided within the inertial body 111, such that movement of the inertial body 111 along the X axis does not compress the air within the cavities 119A, 119B. As a further option, the passage 502 can be removed from the device, with the inertial body 111 being solid, as shown in FIG. 6. This obviously simplifies the manufacturing of the inertial body 111, but can complicate to some extent the calculation of the acceleration, since the behavior of the air in the cavities 119 needs to be taken into account when analyzing the output signal from the Hall sensor 113. As yet a further alternative, the cavities 119A, 119B can be filled with a liquid, preferably one that does not mix with the magnetic liquid 109.

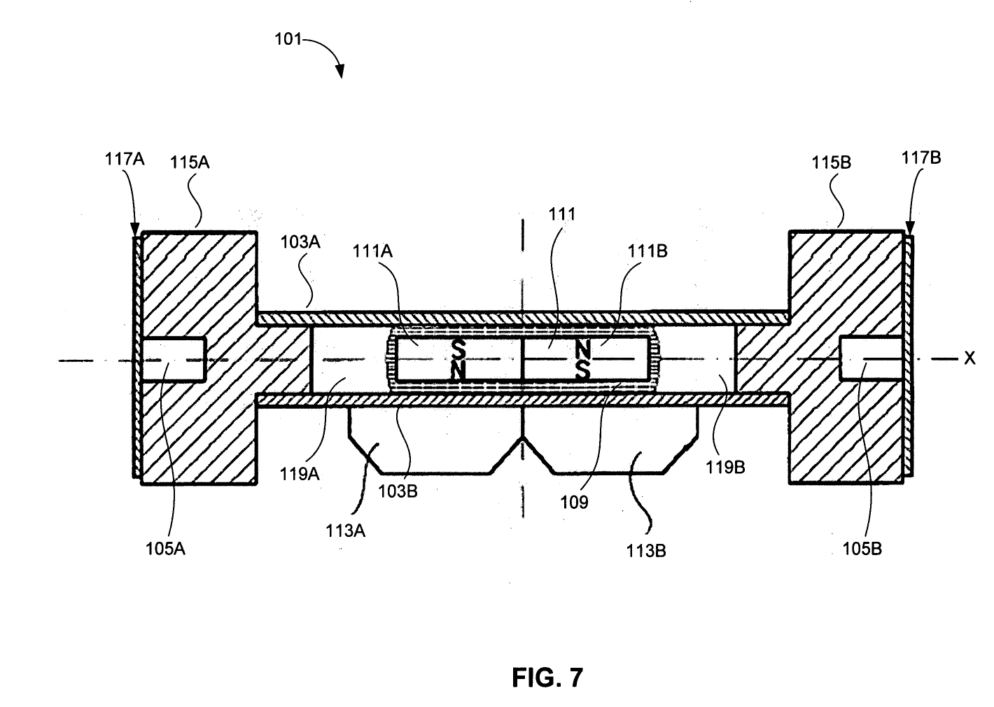

FIG. 7 illustrates yet another embodiment of the invention, where the output signal of the accelerometer 111 is differential, and two Hall sensors 113A, 113B are used. This permits using the accelerometer at greater sensitivity levels, with better temperature stability, as well as with better signal-to-noise ratios.

As yet a further embodiment, the principles described above can be applied to an accelerometer that measures acceleration in two linear coordinates, rather than just one. For example, a square or cross-shaped inertial body can be used. The accelerometer 101 as shown in, for example, FIG. 1 can be modified so that the inertial body moves not just in the X direction (left-right in the figure) but also in the Y direction (into the page and out of the page, in FIG. 1). As will be appreciated by one skilled in the art, many of the other elements illustrated in the figure can be “duplicated” for the other axis—for example, the stops 123, the centering magnets 105, the cavities 119, etc.

One example of the magnetic fluid 109 is kerosene with iron oxide (Fe₃O₄) particles dissolved in the kerosene. The magnetic fluid 109 is a colloidal suspension. Typical diameter of the Fe₃O₄ particles is on the order of 10-20 nanometers (or smaller). The Fe₃O₄ particles are generally spherical in shape, and act as the magnetic dipoles when the magnetic field is applied.

More generally, the magnetic fluid 109 can use other ferromagnetic metals, such as cobalt, gadolinium, nickel, dysprosium and iron, their oxides, e.g., Fe₃O₄, FeO₂, Fe₂O₃, as well as such magnetic compounds as manganese zinc ferrite (ZnₓMn₁₋ₓFe₂O₄), cobalt ferrites, or other ferromagnetic alloys, oxides and ferrites. Also, water or oil can be used as the base liquid, in addition to kerosene.

Having thus described an embodiment of the invention, it should be apparent to those skilled in the art that certain advantages of the described method and apparatus have been achieved. It should also be appreciated that various modifications, adaptations, and alternative embodiments thereof may be made within the scope and spirit of the present invention. The invention is further defined by the following claims.

What is claimed is:

1. An accelerometer comprising:
a housing;
a magnetic fluid within the housing;
an inertial body suspended in the magnetic fluid and generally constrained to move along a single axis, the inertial body including two permanent magnets;
centering magnets positioned on two sides of the inertial body along the single axis; and
a detector providing a signal indicative of acceleration that is based on displacement of the inertial body.

2. The accelerometer of claim 1, further comprising a plurality of stops on the inertial body.

3. The accelerometer of claim 1, further comprising a coil winding magnetically coupled to the inertial body for maintaining the inertial body substantially in place.

4. The accelerometer of claim 1, wherein further comprising cavities on sides of the inertial body.

5. The accelerometer of claim 4, further comprising openings in the housing that connect the cavities to outside environment.

6. The accelerometer of claim 4, wherein the inertial body includes a channel connecting the cavities.

7. The accelerometer of claim 1, wherein the detector is a Hall sensor.

8. The accelerometer of claim 1, wherein the detector is a digital Hall sensor.

9. The accelerometer of claim 1, wherein the detector includes two Hall sensors for differential detection of the acceleration.

10. The accelerometer of claim 1, wherein the detector includes a magnetoresistive sensor.

11. The accelerometer of claim 1, wherein the housing further comprises two lids that substantially enclose, within the housing, magnetic fields from the centering magnets.

12. An accelerometer comprising:
a housing;
a magnetic fluid within the housing;
an inertial body suspended in the magnetic fluid and generally constrained to move in a plane, the inertial body including permanent magnets;
centering magnets positioned on four sides of the inertial body; and
a detector providing a signal indicative of acceleration that is based on displacement of the inertial body.

13. The accelerometer of claim 13, further comprising a coil winding magnetically coupled to the inertial body for maintaining the inertial body substantially in place.

14. The accelerometer of claim 13, wherein further comprising cavities in the housing on sides of the inertial body.

15. The accelerometer of claim 14, wherein the inertial body includes a channel connecting the cavities.

16. The accelerometer of claim 13, wherein the detector is a Hall sensor.

17. The accelerometer of claim 13, wherein the detector is a digital Hall sensor.

18. The accelerometer of claim 13, wherein the detector includes two Hall sensors for differential detection of the acceleration.

19. The accelerometer of claim 13, wherein the housing further comprises two lids that substantially enclose, within the housing, magnetic fields from the centering magnets.

20. The accelerometer of claim 13, wherein the detector includes a magnetoresistive sensor.

21. An accelerometer comprising:
an inertial body suspended in a magnetic fluid, the, the inertial body including two permanent magnets and constrained to move generally along a single axis;
centering magnets positioned around the inertial body; and
a detector providing a signal indicative of acceleration that is based on movement of the inertial body.
